(19) United States
(12) Patent Application Publication
(10) Pub. No.: US 2023/0126709 A1
(43) Pub. Date: Apr. 27, 2023

(54) FLEXIBLE SUBSTRATE TERMINAL

(71) Applicant: Illinois Tool Works Inc., Glenview, IL (US)

(72) Inventors: Karly R. Miller, Lemont, IL (US); Scott D. Bair, Skokie, IL (US)

(21) Appl. No.: 17/897,996

(22) Filed: Aug. 29, 2022

Related U.S. Application Data
(60) Provisional application No. 63/272,481, filed on Oct. 27, 2021.

(51) Int. Cl. H01R 12/65; H01R 4/18; H01R 12/57; H01R 13/11; H01R 13/05

(52) U.S. Cl. CPC H01R 12/65; H01R 4/18; H01R 12/57; H01R 13/11; H01R 13/05

(57) ABSTRACT

A terminal with a connecting end, a midsection, and a crimping end is disclosed. The midsection is adapted to prevent damage to the terminal. The connecting end is configured to be received in a housing. The crimping end is configured to be connected to a substrate. At least two of the connecting end, the midsection, and the crimping end are conductive and formed as a single, unitary component.

### CROSS REFERENCE TO RELATED APPLICATIONS

This application claims priority to and the benefit of U.S. Provisional Patent Application No. 63/272,481 filed in the United States Patent and Trademark Office on Oct. 27, 2021, the entire content of which is incorporated herein by reference.

### BACKGROUND

### 1. Field of the Disclosure

Embodiments of the present disclosure generally relate to flexible circuit assemblies, and more particularly, to staking terminals for flexible circuit assemblies.

### 2. Description of the Background of the Disclosure

Reducing the number connection points in an electrical circuit reduces the risk of connection failures and allows for a more efficient assembly process. Currently the method to make an electrical connection between a terminal block and a circuit on a flexible substrate requires multiple connections. A terminal block is generally described as a connector system that consists of a metal terminal pin (male or female) of a certain design that is joined (crimped) to an electrical conductor such as a copper wire. This subsystem of the terminal crimped to a conductor is placed within a housing made of dielectric material such as plastic. In the case of using this type of terminal block system to connect to a flexible circuit, an operator will need to join the opposite end of the conductor (wire) to an additional crimp terminal. This terminal will then be joined to the flexible circuit. A different terminal that eliminates the wire crimp connections would assemble more efficiently and reduce the risk of connection failures due to failed wire crimps.

### SUMMARY

In one aspect, a terminal for electrical connection to a device and a substrate includes a connecting end, a midsection, and a crimping end. The midsection is a region for preventing damage of the terminal. The connecting end is configured to be received in the housing and to be electrically coupled with the device. The crimping end is configured to be connected to the substrate (e.g., a flexible substrate) or a flexible circuit. The midsection is a region for preventing damage to the terminal. At least two of the connecting end, the midsection, and the crimping end are conductive and formed as a single, unitary component. The housing is configured to accept the connecting end of the terminal. The terminal further includes a latch for preventing inadvertent removal of the terminal from the housing.

### DESCRIPTION OF THE DRAWINGS

FIG. 1 is a side view of a prior art flexible circuit assembly;

FIG. 2A is a side view of an example of a flexible circuit assembly according to some embodiments;

FIG. 2B illustrates an isometric view of an example of a terminal of the flexible circuit assembly according to some embodiments;

FIG. 2C illustrates another isometric view of an example of a terminal of the flexible circuit assembly according to some embodiments;

FIG. 3 is an isometric view of an example of a flexible circuit assembly according to some embodiments;

FIG. 4 is a side view of an example of a flexible circuit assembly taken along line I-I′ of FIG. 3;

FIG. 5 is a top view of an example of a flexible circuit assembly taken along line II-II′ of FIG. 3;

FIG. 6 is a front view of an example of a flexible circuit assembly taken along line of FIG. 3;

FIG. 7 is a rear view of an example of a flexible circuit assembly taken along line IV-IV′ of FIG. 3;

FIG. 8 is an isometric view of an example of a flexible circuit assembly according to some embodiments;

FIG. 9 is an isometric sectional view of an example of a flexible circuit assembly showing a terminal received in a housing according to some embodiments; and

FIG. 10 is an exploded view of an example of a flexible circuit assembly according to some embodiments.

### DETAILED DESCRIPTION OF THE DRAWINGS

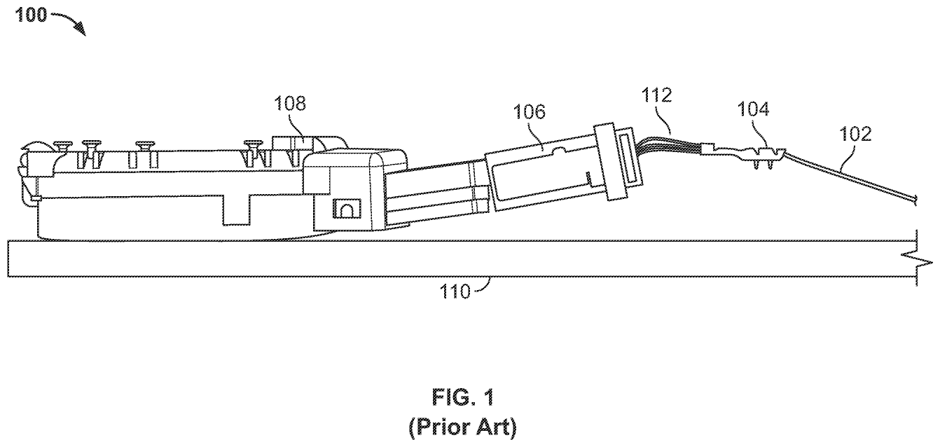

FIG. 1 is a side view of a prior art flexible circuit assembly 100, which includes a flexible substrate 102, a metal terminal 104, a housing 106, a device 108, and a bracket 110. In current systems, connecting the flexible substrate 102 to the device 108 is accomplished by utilization of a stranded copper wire 112. In particular, the housing 106 connects the stranded copper wire 112 to the device 108, while the metal terminal 104 connects the stranded copper wire 112 to the flexible substrate 102. To provide such a connection, a user needs to cut the stranded copper wire 112 to length, strip insulation, crimp a metal connector at each end of the wire 112, insert the terminal-wire subassembly into the housing 106 to one end, i.e., the device end, then crimp the metal terminal 104 to the other end, i.e., the flexible substrate 102. This arrangement is time-consuming to assemble, causes inefficiencies, and increases the cost for creating an electrical connection between the device 108 and the flexible substrate 102. In addition, since the user has to strip the external insulation of the stranded copper wire and snap the metal connector of the wire into the housing 106, the person might damage the core of the copper wire or weaken the joint with the housing 106 or the metal terminal 104. This may lead to communication failure or fatigue and breaking of the copper wire 112. Thus, a need exists for providing a more efficient and robust way of connecting terminals to flexible substrates and devices.

Some embodiments described herein offer solutions to these problems by providing improved terminals for connecting a flexible substrate to a device. In particular, the improved terminals prevent fatigue and breaking of wires by removing the wires and directly connecting improved terminals together. Further, the improved terminals reduce communication errors caused by wires being inappropriately crimped to the housing. In addition, the improved terminals may reduce the time needed to connect wires to the housing. Furthermore, the improved terminals may reduce the number of connection points in an electrical circuit, thereby reducing the risk of connection failures and allowing for a more efficient assembly process.

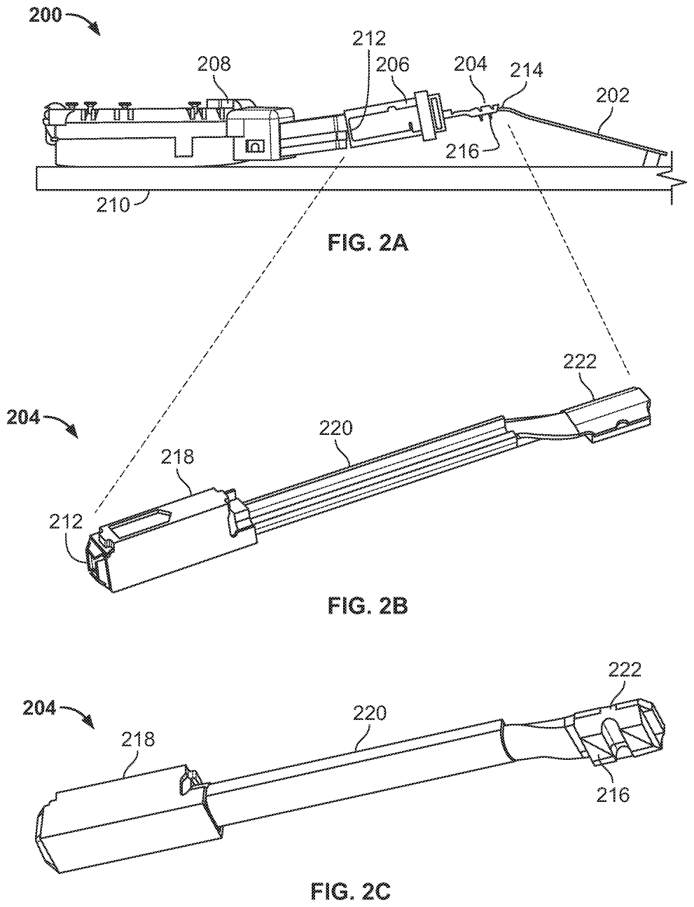

FIG. 2A illustrates a side view of an example flexible circuit assembly 200 according to some embodiments. The flexible circuit assembly 200 includes a flexible substrate 202, a terminal 204 (e.g., a flexible substrate terminal or a low-profile terminal), a housing 206, a device 208, and/or a bracket 210 to support the device 208. In some examples, the device 208 may include a sensor, a heating device, an antenna, an electronic controller, a power train system, a safety and security system, a chassis system, or a power source. However, it should be appreciated that the device 208 may include any suitable electrical or electronic device or system configured to be electrically connected with the flexible substrate 202.

The housing 206 is be configured to accept an electrical contact or a connecting end 218 of the terminal 204 (see FIGS. 2B and 2C) and firmly secure the electrical contact (e.g., the connecting end 218) of the terminal 204. In some examples, the housing 206 is made of a dielectric material such as plastic. In the present embodiment, the terminal 204 features two connection points, i.e., one at the connecting end 218 to the device 208, and the other at the crimping end 222 to the flexible substrate 202. In some examples, the bracket 210 may have a locking mechanism (e.g., a snap-fit, a latch, etc.) to hold the housing 206 in position. The housing 206 may have other additional electrical conductors configured to be connected to the device 208. Also, the housing 206 and terminal 204 may electrically couple with the device 208. In some examples, the housing 206 may be a micro quadlock system (MQS) receptacle housing having one or more channels to receive corresponding electrical contacts (e.g., a connecting end 218) of the terminal 204. Thus, when the housing 206 has multiple channels, the housing 206 may receive a number of connecting ends 218 of corresponding terminals 204. Of course, the number of electrical contacts of the terminal 204 to be received in the housing 206 may be equal to or less than the number of channels of the housing 206. It should be appreciated that an MQS receptable housing is only one example of the housing 206. In fact, the housing 206 may comprise any suitable wire harness housing.

FIG. 2B illustrates an isometric view of an example of the terminal 204, and FIG. 2C illustrates another isometric view of an example of the terminal 204. In some examples, the terminal 204 is a connecting medium to electrically connect the flexible substrate 202 to the housing 206 without using wires. The terminal 204 may, for example, be a one stamped metal piece. The one-piece metal terminal 204 eliminates wires between the terminal 204 and the housing 206 and eliminates a wire crimping connection that connects the wires to the terminal 204 (e.g., a low-profile terminal) and/or the housing 204. The terminal 204 includes a connecting end 218, a midsection 220, and a crimping end 222. The connecting end 218 may be received by or receive the housing 206. For example, an operator may slide the connecting end 218 of the terminal 204 into the housing 206 by pushing the terminal 204 into a channel of the housing 206. For example, the connecting end 218 may include a male or female end of the terminal 204 to accommodate the configuration of the device 208. Thus, the terminal 204 may convey electrical current and/or a signal from the flexible substrate 202 to the device 208 or vice versa. The midsection 220 may provide the necessary mechanical integrity to prevent damage to the terminal 204 without wires between the connecting end 218 and the crimping end 222. Thus, the midsection 220 may prevent fatigue and breaking of the connection between the connecting end 218 and the crimping end 222. In some embodiments, at least two of the connecting end 218, the midsection 220, and the crimping end 222 are conductive and formed as a single, unitary component. In a non-limiting scenario, the connecting end 218 and the midsection 220 can be conductive and formed as a single, unitary component, and the crimping end 222 as a separate component can be connected to the connecting end 218 and the midsection 220. In another non-limiting scenario, the midsection 220 and the crimping end 222 can be conductive and formed as a single, unitary component, and the connecting end 218 as a separate component can be connected to the midsection 220 and the crimping end 222. In further embodiments, the connecting end 218, the midsection 220, and the crimping end 222 are conductive and formed as a single, unitary component to form one metal piece. The connecting end 218, the midsection 220, and crimping end 222 are devoid of a stranded wire to provide a conductive pathway between the housing 206 and the flexible substrate 202.

In further examples, the terminal 204 may connect directly into the housing 206 at one end 212 (or a first end) of the terminal 204 and be electrically coupled with the housing 206 without using a wire. For example, at the first end 212 of the terminal 204, the terminal 204 may be configured to electrically couple the terminal 204 with the housing 206. In further embodiments, the terminal 204 may be directly connected to the housing 206. In some embodiments, the terminal 204 may include a connecting end 218 that is configured to be mated with a corresponding channel of the housing 206. In some instances, the connecting end 218 may be a substantial cuboid to be received in the housing and electrically coupled with the housing 206. It should be appreciated that the connecting end 218 can be any other suitable shape (e.g., a prism, a cylinder, etc.). In other examples, the connecting end may include a blade crimp connector, a ring crimp connector, a spade crimp connector, a bullet crimp connector, or any other suitable electrical contact for mating the terminal 204 to the housing 206. In further examples, a connecting end 218 may include a metal lance or a metal tine at the end of the connecting end 218 to facilitate the mating between the housing 206 and the terminal 204. The metal lance may be made of a material having a low level of resistivity and a high level of conductivity. At the same time, the metal lance may have a high level of durability. For example, the connecting end 218 may be a one-piece metal lance, which is securely received in the housing 206. Thus, the electrical contact may prevent fatigue and breaking. In further examples, the connecting end 218 may have one or more locking latches or locking tangs to firmly fix the terminal 204 to the housing 206. It should be appreciated that the locking latches and the locking tangs are mere examples. The terminal 204 may include any other suitable locking mechanism to provide the mechanical retention force of the terminal to the housing 206.

In some examples, the connecting end 218 may include an external housing. For example, the external housing can be received in the housing 206 and can be electrically coupled with the device 208. The external housing of the connecting end 218 may be firmly secured in a channel of the housing 206 when the external housing of the connecting end 218 is received in the housing 206. In some examples, the external housing of the connecting end 218 may have a locking latch to firmly fix the terminal 204 to the housing 206. In other examples, the connecting end 218 may be made of aluminum, molybdenum, zinc, or any other suitable metal. In further examples, the terminal 204 may be a metal terminal that conveys an electrical signal from/to the flexible substrate 202 to/from the device 208 via the housing 206. In further examples, the terminal 204 may include multiple connecting ends 218 to be received in multiple corresponding channels of the housing 206.

In some examples, the terminal 204 may be connected to, and electrically coupled with, the substrate 202 (e.g., flexible substrate) at the crimping end 222 of the terminal 204. The crimping end 222 may have one or more tines 216 (e.g., multiple piercing tines 216) to secure the flexible substrate 202 to the terminal 204. The terminal 204 may crimp, pinch, or pierce (e.g., bite) the flexible substrate 202 to the piercing tines 216 of the terminal 204. For example, the multiple piercing tines 216 of the crimping end 222 may be oriented at a right angle to the crimping end 222 and the flexible substrate 202 before the multiple tines 216 crimp the flexible substrate 202. When the multiple piercing tines 216 crimp the flexible substrate 202, the multiple piercing tines 216 pierce the flexible substate 202 and are configured to be folded over to capture and hold the flexible substrate 202. Thus, the crimped multiple tines 216 can be placed to be substantially parallel to the flexible substrate 202 as shown in FIG. 2B. Thus, the crimping end 222 may be connected to and electrically coupled with a silver conductive trace on the flexible substrate 202. In some examples, the crimping end 222 may use a zero-insertion force (ZIF) socket to secure the flexible substrate 202 using an actuator or a non-zero insertion force (non-ZIF) socket for the flexible substrate 202 to be fixed with friction. However, it should be appreciated that securing the flexible substrate 202 to the terminal 204 is not limited to the tines, the ZIF socket, or the non-ZIF socket. Rather, any other suitable socket or connector to electrically mate the flexible substrate 202 with the terminal 204 may be used. Thus, the terminal 204 may convey the electric current or signal to/from the flexible substrate 202 via the crimping end 222.

The substrate 202 may include a flexible circuit (e.g., flexible substrate), or may be a flexible circuit that is covered by a flexible protective layer. The flexible substrate or film 202 may include multiple layers of the same or different material, such as a polymer, a plastic, a cellulosic material, a laminated material, a recycled material, and/or combinations thereof. The flexible substrate 202 may further serve as a resistance element, a conductive element, a mechanical connection, or as a film substrate. In some embodiments, the flexible substrate 202 may include a Mylar® print.

The flexible substrate 202 may include silver conductive traces configured to be electrically coupled with the terminal 204 (e.g., the crimping end of the terminal). The flexible substrate 202 may be formed from a wide variety of well-known polymeric materials, including, for example, polyethylene (PE), low density polyethylene (LDPE), high density polyethylene (HDPE), polyethylene terephthalate (PET), crystalline PET, amorphous PET, polyethylene glycol terephthalate, polystyrene (PS), polyamide (PA), polyvinyl chloride (PVC), polycarbonate (PC), poly(styrene:acrylonitrile) (SAN), polymethylmethacrylate (PMMA), polypropylene (PP), polyethylene naphthalene (PEN), polyethylene furanoate (PEF), PET homopolymers, PEN copolymers, PET/PEN resin blends, PEN homopolymers, overmolded thermoplastic elastomers (TPE), fluropolymers, polysulphones, polyimides, cellulose acetate, and/or combinations thereof. It should be appreciated that the materials listed above are mere examples and could be any other suitable material to offer protection form environmental elements and insulation from electrical short conditions. It is further envisioned that the flexible substrate 202 may include a lining or coating. While particular flexible substrates 202 are disclosed herein, the principles of the present application may be applied to any flexible film.

Thus, the terminal 204 with the housing 206 may allow for connecting and electrically coupling the flexible substrate 202 with the device 208 without a wire. Accordingly, since the terminal 204 may be configured to connect the housing 206 to the flexible substrate 202 without using a wire, the improved terminal 204 has no issues of wires being fatigued and broken between the housing 206 and the terminal 204. Further, the improved terminal 204 can reduce communication errors caused by wires being inappropriately crimped to the housing 110 and reduce the time needed to connect wires to the housing 206 and the terminal 204.

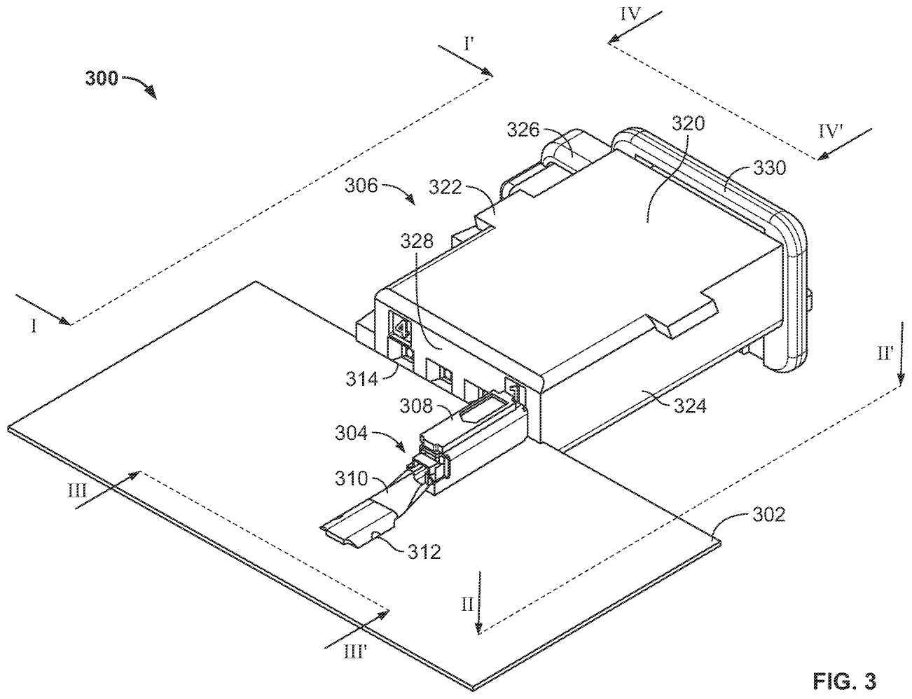

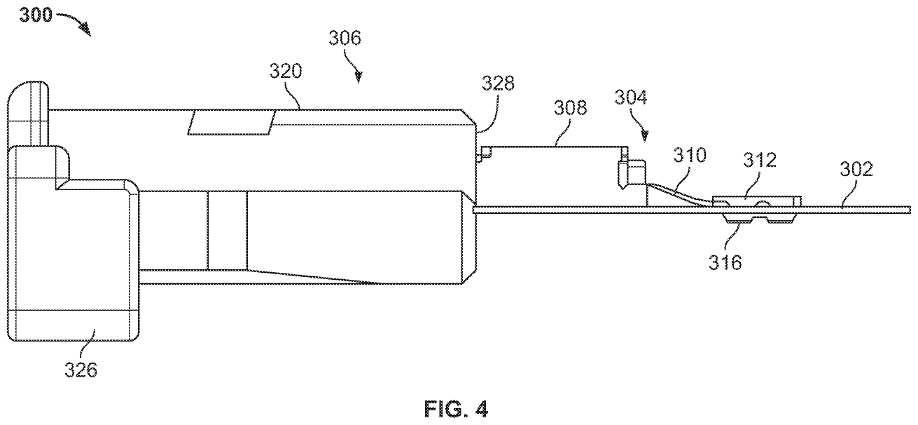

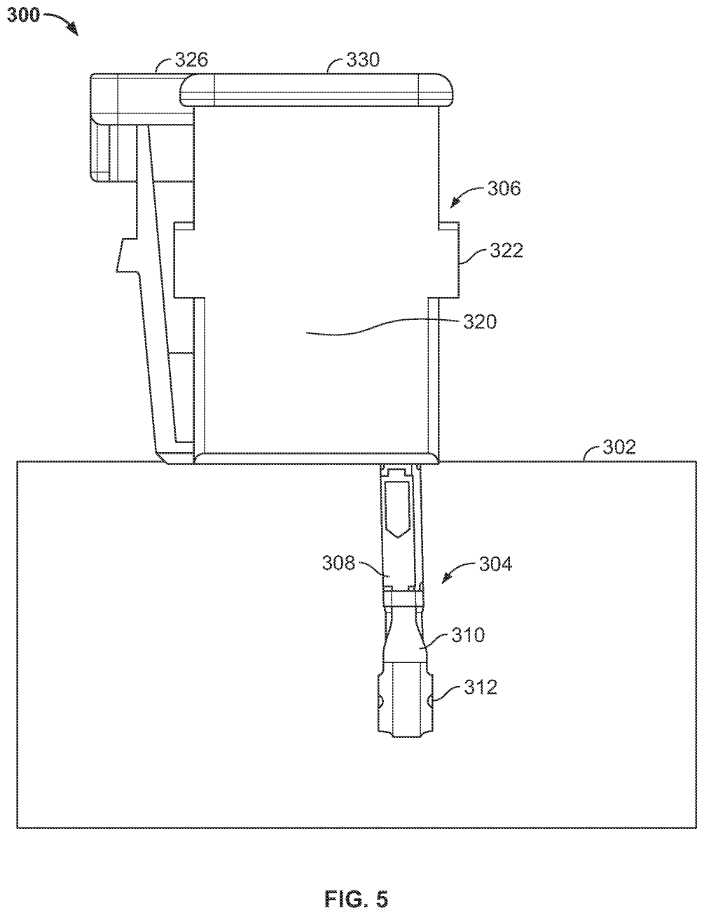

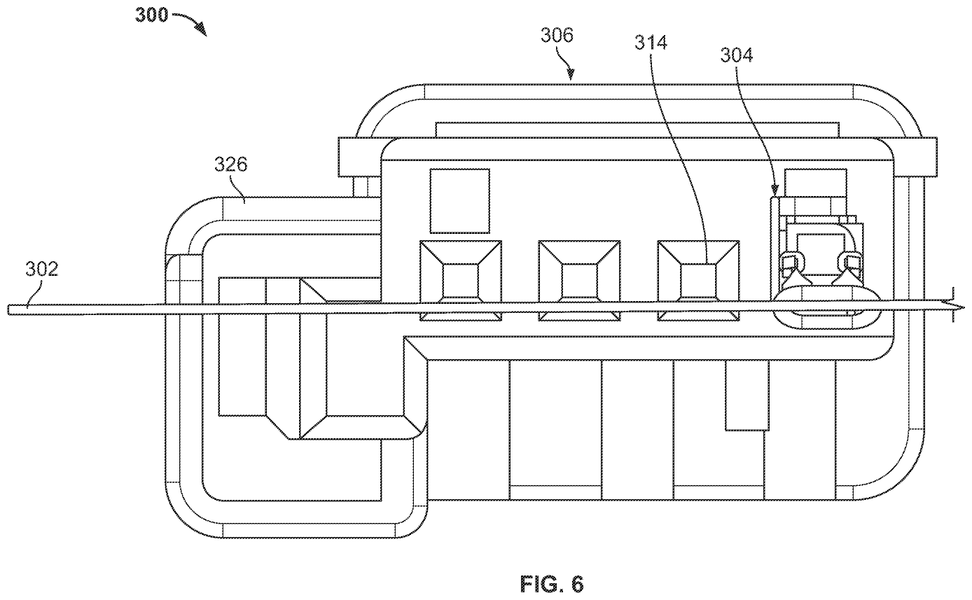

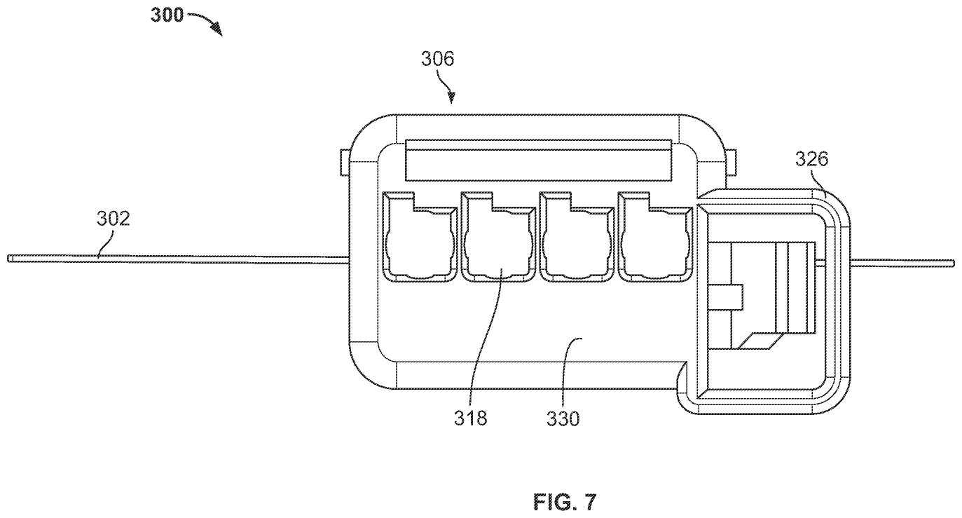

FIGS. 3-7 illustrate another embodiment of a flexible circuit assembly 300. FIG. 4 is a side view of the flexible circuit assembly 300 taken along line I-I′ of FIG. 3, FIG. 5 is a top view of the flexible circuit assembly 300 taken along line II-II′ FIG. 3, FIG. 6 is a front view of the flexible circuit assembly 300 taken along line of III-III′ FIG. 3, and FIG. 7 is a rear view of the flexible circuit assembly 300 taken along line of III-III′ FIG. 3. Among the various views of the flexible circuit assembly 300, FIG. 4 illustrates a similar side view of the flexible circuit assembly 300 as the flexible circuit assembly 200 of FIG. 2. In some embodiments, a housing 306 shown in FIGS. 3-7 may correspond to the housing 206 in FIG. 2, a terminal 304, 302, 326 in FIGS. 3-7 may correspond to the terminal 204 in FIG. 2, and/or a flexible substrate 308 in FIGS. 3-7 may correspond to the flexible substrate 202 in FIG. 2.

In some embodiments, the flexible circuit assembly 300 of FIG. 3 may include the housing 306 for electrically coupling the terminal 304 with a device (not shown in FIGS. 3-7), and/or the terminal 304 for connecting and electrically coupling the housing 306 with the flexible substrate 302. In FIG. 3, the housing 306 may have one or more channels 314. Further, the housing 306 may have multiple housing sockets 318 (shown in FIG. 7) configured to be connected to the device. Turning to FIG. 3 again, the housing 306 may have a housing top wall 320, multiple housing side flanges 322, multiple housing surfaces 324, and a housing attachment point 326. The housing attachment point 326 may be utilized to hold wire harnesses during assembly. The exterior surface of the housing 306 may be bounded by the first housing wall 328, the second housing wall 330, the housing top wall 320, the plurality of housing side flanges 322, and the housing attachment point 326. The multiple channels 314 may be within or along the first housing wall 328.

A channel 314 of the housing 306 may receive the connecting end 308 of the terminal 304. The multiple housing sockets 318 may be disposed within or along the second housing wall 330 (see FIG. 7). The plurality of housing inlet sockets 318 can, in at least one embodiment, be used to electrically connect the device to the flexible substrate 302. With reference to FIG. 3, the housing top wall 320 may be defined by the surface closest in proximity to the plurality of housing side flanges 322 that project from the exterior of the housing 306. The plurality of housing surfaces 324 may define the remainder of the surfaces that bound the exterior of the housing 306. In some embodiments, the terminal 304 may include the connecting end (e.g., male end) 308, the midsection 310, and the crimping end 312 in a single, unified, stamped metal part. Alternatively, the terminal 304 can be formed by casting or other equivalent forms of manufacture. Further, the terminal 304 is not limited to being metal or metallic but can be formed of any material that can carry electrical current and/or a signal to the flexible substrate 302 or the device.

Referring to FIG. 4, a left side view of the flexible circuit assembly 300 is shown and illustrates the first housing wall 328 of the housing 306 being electrically coupled with a connecting end 308 of the terminal 304. As explained above, the terminal 304 is a one-piece metal terminal that may include the connecting end 308, the midsection 310, and the crimping end 312 so as to electrically couple with the flexible substrate 302 and the housing 306 without wires. In some embodiments, the housing 306 may receive the connecting end 308 of the terminal 304 to mate the terminal 304 with the housing 306. The flexible substrate 302 may be connected to the terminal 304 at the crimping end 312. In addition, piercing tines 316 are shown opposite the crimping end 312, with the flexible substrate 302 sandwiched in between.

Referring to FIG. 5, a top view of the flexible circuit assembly 300 is shown. The housing 306 may be electrically coupled with the terminal 304 via the connecting end 308. The terminal 304 may be connected to the flexible substrate 302 via the crimping end 312. Further, the terminal 304 may also include the midsection 310 to connect the connecting end 308 to the crimping end 312 without wires.

FIG. 6 depicts a front view of the flexible circuit assembly 300. The flexible circuit assembly 300 may include the flexible substrate 302, the multiple channels 314, and the terminal 304, which is connected to the housing 306.

FIG. 7 depicts a rear view of the flexible circuit assembly 300. The flexible substrate 302, the multiple housing sockets 318 configured to be connected to the device, and the housing 306 are shown.

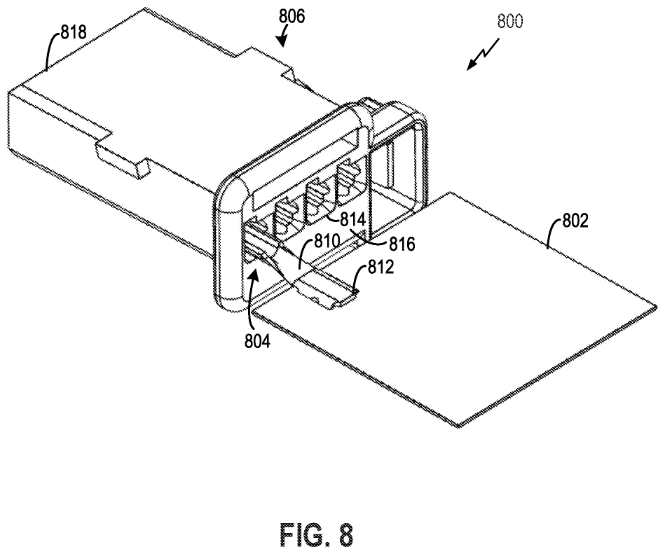

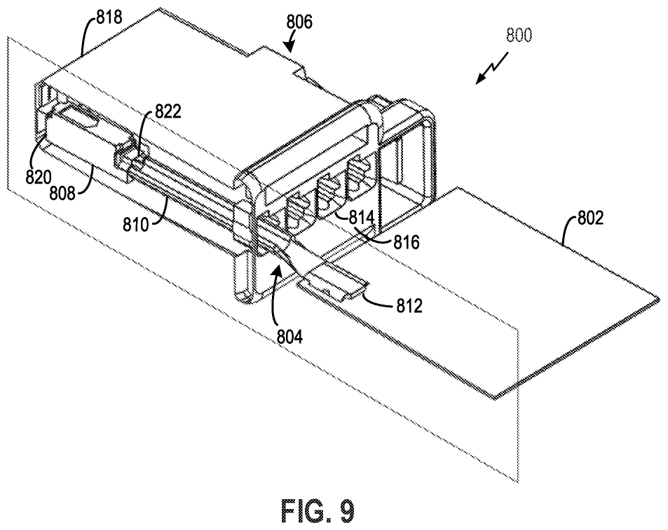

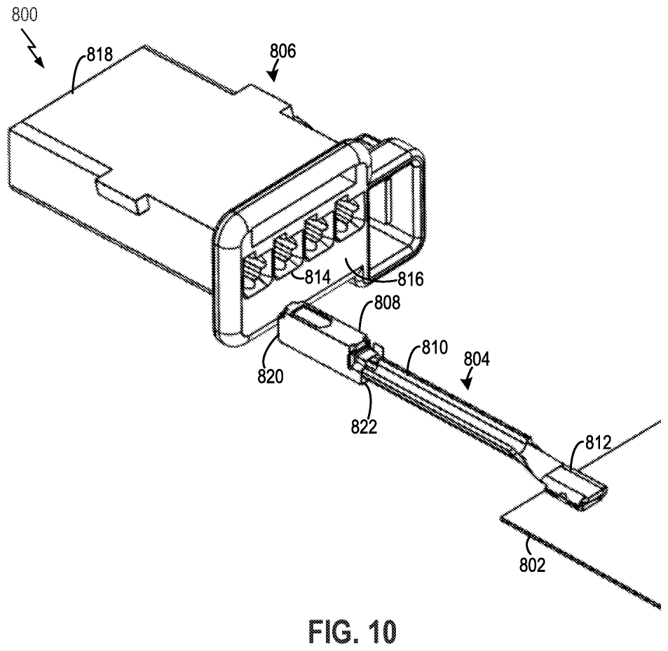

FIGS. 8-10 illustrate another example of a flexible circuit assembly 800 according to some embodiments. FIG. 8 is an isometric view of the flexible circuit assembly 800, FIG. 9 is an isometric sectional view of the flexible circuit assembly 800 to show a terminal 804 received in a housing 806, and FIG. 10 is an exploded view of the flexible circuit assembly 800.

In some embodiments, the flexible circuit assembly 800 of FIG. 8 may include a flexible substrate 802, a terminal 804, and a housing 806.

As shown in FIG. 8, the terminal 804 is configured to be received in the housing 806 via a channel 814. The terminal 804 can be secured in the housing 806 to electrically couple the terminal 804 with a device (not shown in FIG. 8 but shown as 208 in FIG. 2A) connected to the housing 806. In some embodiments, the terminal 804 may be a one-piece electrical conductor to allow the flow of the electrical current in one or more directions. Thus, the terminal 804 can convey the electrical current and/or a signal from/to the flexible substrate 802 to/from the device connected to a second side 818 of the housing 806 that is an opposite side to a first side 816 having the channel 814 of the housing 806 without using wires.

FIG. 9 is an isometric sectional view of the flexible circuit assembly 800 showing a terminal 804 received in a housing 806. The terminal 804 may include a connecting end 808, a midsection 810, and a crimping end 812. The connecting end 808 enters the housing 806 via a channel 814 at a first side 816 and extends toward a second side 818 of the housing 806 opposite to the first side 816 having the channel 814. The connecting end 808 of the terminal 804 also includes a first end 820 and a second end 822. In some embodiments, the first end 820 of the connecting end 808 may be configured to be connected to and/or electrically coupled with an electrical contact or an electrical conductor adjacent the second side 818 of the housing 806. The electrical contact of the housing 806 may be configured to be connected to the device. For example, the first end 820 may be received in the device housing to be connected to an electrical contact within the housing 806. The first end 820 may include a male or a female connector to be mated with a female or male electrical conductor within the housing 806. In other embodiments, the housing can be made of a dielectric material to secure the terminal 804 within the housing. The terminal 804 in the housing 806 may be directly connected to the device. That is, the device may include an electrical connector that is configured to be directly connected to the connecting end 808 of the terminal 804.

The second end 822 of the connecting end 808 is joined to the midsection 810. In some embodiments, the connecting end 808 and the midsection 810 of the terminal 804 are integrally formed as a single piece. However, it should be appreciated that the connecting end 808 and the midsection 810 of the terminal 804 may be separate pieces. For example, the midsection 810 utilizes a securing mechanism to fixedly attach the midsection 810 to the connecting end 808. For example, the midsection 810 may include a latch to firmly secure the connecting end 808 to the midsection 810. In some examples, the latch may include an ‘L’ shaped locking latch to lock the latch to a locking tab of the connecting end 808. Alternatively, the connecting end 808 may include an ‘L’ shaped locking latch while the midsection 810 may include a locking tab. While an exemplary securing mechanism has been described herein, it is contemplated that any suitable securing mechanism may be utilized to secure the midsection 810 to the connecting end 808.

The midsection 810 is a rigid electrical conductor, which provides for the connection of the connecting end 808 to the crimping end 812 to allow for the flow of electrical current or a signal therebetween. In some embodiments, the midsection 810 may be an elongated metal piece. In further embodiments, the midsection 810 is substantially a half-cylindrical shape such that the elongated cylinder is truncated longitudinally to prevent the midsection 810 from being flexible or bent. However, it should be appreciated that the shape of the midsection 810 could be any other suitable shape (e.g., cylinder, cuboid, or any other suitable shape). The size of the midsection 810 may be determined based on the size of the housing 806 that is configured to receive the terminal 804. The midsection 810 provides the necessary mechanical integrity to prevent damage to the terminal 804 without wires between the connecting end 808 and the crimping end 812. Thus, the midsection 810 prevents or otherwise reduces the possibility of part fatigue and the breaking of the connection between the connecting end 808 and the crimping end 812. As described above, the midsection 810 may be integral with the terminal 804 and provided as one component, or a separate metal piece configured to be connected to the connecting end 808.

The crimping end 812 is joined to the midsection 810 of the terminal 804. The crimping end 812 is also adapted to be electrically coupled with the flexible substrate 802 and to convey the electrical current or signal to or from the flexible substrate 802. The crimping end 812 may be integrally joined to the midsection 810 to form a single piece, or a separate metal piece configured to be connected to the midsection 810 of the terminal 804. It is also contemplated that the connecting end 808, the midsection 810, and the crimping end 812 may be fashioned as a one-piece metal terminal 804 in a different embodiment. The crimping end 812 may be substantially similar to the crimping end 222, 312 of the terminal 200, 300 in connection with FIGS. 2A-2C and 3-5.

FIG. 10 is an exploded view of the flexible circuit assembly 800 and depicts the terminal 804 before it is received in the channel 814 of the housing 806. The first end 820 of the connecting end 808 is inserted into the channel 814 so that the first end 820 is disposed adjacent the second side 818 of the housing 806. In some embodiments, the second side 818 of the housing 806 may include a male or female end to be mated with the connecting end 808. In other embodiments, the second side 818 of the housing may include a hole to directly connect the terminal 804 to the device. For example, when the terminal 804 is inserted into the housing, the first end 820 can be exposed through the hole of the second side 818 of the housing 806. Then, the device may be directly connected to the first end 820 of the terminal.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The terms “about” and “approximately” indicate plus or minus 5% of the numeric value that each term precedes. The entire disclosure of each patent and publication cited herein is incorporated by reference, as if each such patent or publication were individually incorporated by reference herein.

We claim:

1. A terminal for electrical connection to a device and a substrate, wherein the terminal comprises:
a connecting end configured to be received in a housing and to be electrically coupled with the device;
a midsection; and
a crimping end configured to be connected to the substrate,
wherein at least two of the connecting end, the midsection, and the crimping end are conductive and formed as a single, unitary component.

2. The terminal of claim 1, wherein the connecting end, the midsection, and the crimping end are devoid of a stranded wire to provide a conductive pathway between the housing and the substrate.

3. The terminal of claim 1, wherein the connecting end, the midsection, and the crimping end are conductive and formed as the single, unitary component.

4. The terminal of claim 1, wherein the terminal further comprising a latch for preventing inadvertent removal of the terminal from the housing.

5. The terminal of claim 1, wherein the connecting end of the terminal comprises a plurality of connecting ends configured to be received in a plurality of corresponding channels of the housing.

6. The terminal of claim 1, wherein the midsection of the terminal is a rigid electrical conductor.

7. The terminal of claim 1, wherein the midsection of the terminal is firmly fixed to the connecting end and the crimping end.

8. The terminal of claim 1, wherein the midsection of the terminal is substantially a half-cylindrical shape.

9. The terminal of claim 1, wherein the crimping end comprises one or more piercing tines to secure the terminal to the substrate.

10. The terminal of claim 1, wherein the connecting end comprises a male end or a female end configured to be connected to a female and or a male end of the housing, respectively.

11. A circuit assembly, comprising:
a terminal comprising a connecting end, a midsection, and a crimping end,
wherein the midsection is adapted to prevent damage to the terminal,
wherein the connecting end is configured to be received in a housing, and
wherein the crimping end is configured to be connected to a substrate,
wherein at least two of the connecting end, the midsection, and the crimping end are conductive and formed as a single, unitary component.

12. The circuit assembly of claim 11, wherein the connecting end, the midsection, and the crimping end are devoid of a stranded wire to provide a conductive pathway between the housing and the substrate.

13. The circuit assembly of claim 11, wherein the connecting end, the midsection, and the crimping end are conductive and formed as the single, unitary component.

14. The circuit assembly of claim 11, wherein the terminal further comprises a latch for preventing inadvertent removal of the terminal from the housing.

15. The circuit assembly of claim 11, wherein the connecting end of the terminal comprises a plurality of connecting ends configured to be received in a plurality of corresponding channels of the housing.

16. The circuit assembly of claim 11, wherein the midsection of the terminal is a rigid electrical conductor.

17. The circuit assembly of claim 11, wherein the midsection of the terminal is firmly fixed to the connecting end and the crimping end.

18. The circuit assembly of claim 11, wherein the midsection of the terminal is substantially a half-cylindrical shape.

19. The circuit assembly of claim 11, wherein the crimping end comprises one or more piercing tines to secure the terminal to the substrate.

20. The circuit assembly of claim 11, wherein the connecting end comprises a male end or a female end configured to be connected to a female and or a male end of the housing, respectively.
